(19) United States
(12) Patent Application Publication
(10) Pub. No.: US 2012/0315388 A1
(43) Pub. Date: Dec. 13, 2012

(54) BONDING SYSTEM COMPRISING AN ADHESIVE OR SEALANT AND A PRIMER

(75) Inventors: Urs BURCKHARDT, Zurich (CH); Wolf Rüdiger HUCK, Gockhausen (CH); Antonio CORSARO, Regensdorf (CH); Judith GRIMM, Zurich (CH)

(73) Assignee: SIKA TECHNOLOGY AG, Baar (CH)

(21) Appl. No.: 13/492,150

(22) Filed: Jun. 8, 2012

(30) Foreign Application Priority Data
Jun. 8, 2011 (EP) 11169184.6

(51) Int. Cl. C09J 163/00; B05D 5/10; C08K 5/17; B82Y 30/00

(52) U.S. Cl. 427/207.1; 523/402; 523/404; 977/773

(57) ABSTRACT

An adhesive system, including a bonding agent composition containing at least one aqueous dispersion of a solid epoxy resin; and at least one polyamine; and an adhesive or sealant, containing at least one compound V in free or hydrolytically releasable form, which can react with the polyamine in a condensation reaction, wherein an adhesive system can result in improved adhesion under humid and warm conditions.

### RELATED APPLICATION(S)

This application claims priority under 35 U.S.C. §119 to European Patent Application No. 11169184.6 filed in Europe on Jun. 8, 2011, the entire content of which is hereby incorporated by reference in its entirety.

### FIELD

The disclosure relates to the field of elastic adhesives and sealants, as well as bonding agents for such adhesives and sealants.

### BACKGROUND INFORMATION

Adhesives and sealants are used for bonding and sealing of various materials. To improve the adhesion of adhesives and sealants on different substrates, bonding agent compositions can be used, which can be applied as primers on the surface or substrate.

Such bonding agent compositions can contain volatile organic compounds (VOCs) as solvents which evaporate during application, and which can be undesirable for environmental, occupational health and safety reasons. Therefore, attempts are made to replace solvent-based bonding agent compositions by aqueous ones. Aqueous bonding agent compositions, however, can lose their bonding in the adhesion under humid and warm conditions such as in cataplasm storage, which can result in failure of the entire adhesive system. An aqueous bonding agent composition with relatively good stability under humid and warm conditions, for example, is described in WO 2008/037780. It represents a two-component system consisting of an epoxy resin dispersion and an amine curing agent. During longer cataplasm storage, however, this bonding agent composition can display a loss of adhesion.

### SUMMARY

According to an exemplary aspect, an adhesive system is disclosed, comprising: a bonding agent composition containing: at least one aqueous dispersion of a solid epoxy resin; and at least one polyamine; and an adhesive or sealant containing: at least one compound V in free or hydrolytically releasable form, which is capable of reacting with the polyamine in a condensation reaction.

According to another exemplary aspect, a process for using an exemplary adhesive system is provided, the process comprising: i) applying a bonding agent composition to a substrate, wherein the bonding agent composition contains: at least one aqueous dispersion of a solid epoxy resin; and at least one polyamine; and ii) applying an adhesive or sealant at least partially to the site at which the bonding agent composition was applied, wherein the adhesive or sealant contains: at least one compound V in free or hydrolytically releasable form, which is capable of reacting with the polyamine in a condensation reaction.

### DETAILED DESCRIPTION

According to an exemplary embodiment, an adhesive system is provided, the bonding agent composition of which releases no or only insignificant amounts of volatile organic compounds, wherein the system at the same time does not result in a loss of adhesion under humid and warm conditions.

The presence of a compound V in an adhesive or sealant can significantly improve the stability of the underlying bonding agent composition under humid and warm conditions. Thus, the stability of the adhesive system can be ensured under humid and warm conditions. In addition, the field of application of existing bonding agent compositions, which can suffer a loss of adhesion under humid and warm conditions, can be expanded.

According to an exemplary aspect, disclosed is an adhesive system comprising

a bonding agent composition containing

at least one aqueous dispersion of a solid epoxy resin; and

at least one polyamine;

and
an adhesive or sealant containing

at least one compound V in free or hydrolytically releasable form, which can react with the polyamine in a condensation reaction.

In this document, substance names beginning with “poly”, such as polyamine or polyisocyanate, refer to substances which contain two or more functional groups per molecule that occur in the substance name.

In this document, “polyamine” compounds are understood to have two or more amino groups.

In the present document, the term “polymer” comprises a group of chemically uniform macromolecules that differ with respect to their degree of polymerization, molecular weight and chain length, formed in a polyreaction (polymerization, polyaddition, polycondensation). The term also includes derivatives of such a group of macromolecules from polymerization reactions, for example, compounds obtained by reactions such as addition or substitution of functional groups at existing macromolecules, and which may be chemically uniform or chemically non-uniform. The term also includes so-called prepolymers, for example, reactive oligomeric preadducts, the functional groups of which are involved in the synthesis of macromolecules.

The term “polyurethane polymer” includes all polymers which are prepared by the so-called polyisocyanate polyaddition process. This also includes those polymers which are virtually or entirely free from urethane groups. Examples of polyurethane polymers are polyether polyurethanes, polyester polyurethanes, polyether polyureas, polyureas, polyester polyureas, polyisocyanurates and polycarbodiimides.

“Cataplasm storage” refers to the storage of a specimen at a temperature of 70° C. and a relative humidity of 100%.

In the present document, the term “molecular weight” refers to the mean molecular weight Mn (number average).

The solid epoxy resin of the aqueous dispersion is, for example, a solid epoxy resin of formula (I).

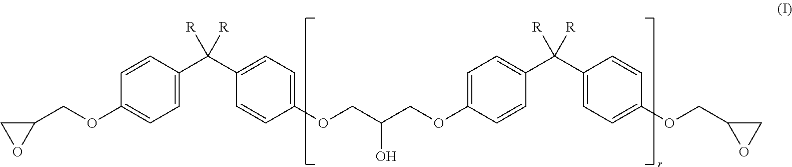

The substituents R each independently are a hydrogen atom or a methyl group. In addition, the index r is a value of >1, for example, 1.5. For example, r is 2 to 12.

For example, a solid epoxy resin has a glass transition temperature above room temperature of about 23° C. Solid epoxy resins can be broken into free-flowing powders at room temperature.

Exemplary solid epoxy resins, as such or already present in dispersed form, for example, are commercially available from Dow Chemical Company, USA, from Huntsman International LLC, USA, or from Hexion Specialty Chemicals Inc, USA.

Suitable solid epoxy resins are also, for example, those having, at least in part, N-glycidyl groups instead of glycidyl ether groups, and epoxy resins based on aliphatic glycidyl ethers.

Suitable solid epoxy resins are also those selected from the group of phenolic resins, for example, phenol or cresol novolaks.

Optionally, the aqueous dispersion of a solid epoxy resin contains additional constituents such as liquid epoxy resins, emulsifiers, co-emulsifiers, anti-foaming agents, biocides, pigments, fillers, reactive diluents or catalysts.

The aqueous dispersion of a solid epoxy resin can have a content of solid epoxy resin of 30 to 80 wt-%, for example, 50 to 70 wt-%. Accordingly, the aqueous dispersion of an epoxy resin, for example, contains about 20 to 70 wt-% water.

The average particle size of the dispersed particles of solid epoxy resin in the dispersion is, for example, in the range of 0.05 to 20 μm, for example, 0.1 to 10 μm, for example, 0.2 to 5 μm.

For example, suitable aqueous dispersions of a solid epoxy resin are commercially available from Cognis under the trade name Waterpoxy® 1422 or from Air Products under the trade name Ancarez™ AR555 Waterborne Epoxy Resin.

The proportion of the aqueous dispersion of a solid epoxy resin can be 30 to 99 wt-%, for example, 40 to 80 wt-%, based on the total bonding agent composition.

Furthermore, the bonding agent composition of the disclosure comprises at least one polyamine.

Suitable polyamines are described, for example, in European Patent Application No. EP 09178262.3, the content of which is incorporated herein by reference.

For example, the polyamine is a reaction product, for example, a polyamidoamine or an epoxy resin/polyamine addition product.

For example, the polyamine is a polyamidoamine. These include, for example, condensation products of carboxylic acids and polyamines, for example, a fatty acid and a polyalkylene amine.

Suitable polyamines are addition products of epoxy resins and polyamines. Such addition products can be obtained, for example, from a plurality of possible polyamines and epoxy resins, for example, bisphenol A diglycidyl ether. Exemplary polyamines are ethylene diamine, isophorone diamine, 2,2,4- and 2,4,4-trimethylhexamethylene diamine, 1,3-xylylene diamine, polyalkylene amines, such as polyethylene amines or polyoxyalkylene diamines or triamines, for example, those available from Huntsman under the trade name Jeffamine®. For example, the reaction product is that of a diglycidyl ether of bisphenol A and/or bisphenol F with a polyoxyalkylene diamine or polyoxyalkylene triamine. An exemplary suitable addition product is the one which is described in EP 0567831 as bis-(diamine)-diepoxide adduct.

It is possible and may be desirable to use a mixture of different polyamines in the bonding agent composition. Optionally, mixtures of polyamines and mercapto-containing compounds may also be used.

The proportion of the polyamine can be, for example, chosen such that in the bonding agent composition the ratio of amino groups to epoxy groups lies in the range of 0.1:1 to 1:1.

For example, the proportion of the polyamine is 1 to 40 wt-%, for example, 5 to 20 wt-%, based on the total bonding agent composition.

For example, the bonding agent composition of the adhesive system of the disclosure can contain other ingredients, such as those that are suitable in bonding agent compositions and are described, for example, in WO 2008/037780, for example, those compounds that are described therein as epoxy-silane ES or ESx, aminosilanes AS or ASx or mercaptosilanes MS.

For example, the bonding agent composition contains silanes, optionally, at least in part, in the form of their siloxanes, and pigments. Exemplary silanes are epoxy silanes, for example, 3-glycidoxypropylsilanes and aminosilanes, for example, 3-aminopropylsilanes and N-(2-aminoethyl)-3-aminopropylsilanes, adducts of epoxy silanes and aminosilanes, and mercaptosilanes, for example, 3-mercaptopropylsilanes.

Exemplary pigments include iron pigments and, for example, soot.

The bonding agent composition can be used, for example, as a two-component system, wherein the aqueous dispersion of the solid epoxy resin is contained in the first component and the polyamine is contained in the second component.

In an exemplary embodiment, the bonding agent composition is a two-component bonding agent composition composed of a first component K1, containing

at least one aqueous dispersion of a solid epoxy resin;

and
a second component K2 containing

at least one polyamine.

For example, after preparation, the individual components of the bonding agent composition are packaged separately from each other in tight packages. The individual components are stable when stored separately from each other. The bonding agent composition of the disclosure is stored, for example, at temperatures in the range of 5 to 30° C. This can ensure the stability of the aqueous dispersion of the solid epoxy resin.

The adhesive system of the disclosure comprises at least one adhesive or sealant containing at least one compound V in free or hydrolytically releasable form, which can react with the polyamine in a condensation reaction.

The adhesive or sealant used can be, for example, any suitable adhesive or sealant. For example, it is a moisture-curing adhesive or sealant.

Suitable adhesives and sealants are, for example, polyurethane adhesives and sealants, for example, those containing polyurethane polymers having isocyanate groups.

Furthermore, the bonding agent composition of the disclosure can be suitable for silane-crosslinking adhesives and sealants.

The bonding agent composition of the disclosure can be suitable for elastic moisture-curing adhesives such as, for example, those sold commercially by Sika AG, Switzerland, under the product lines Sikaflex® and SikaBond®.

Exemplary adhesives and sealants are polyurethane adhesives and sealants, containing polyurethane polymers having isocyanate groups, and silane-crosslinking adhesives and sealants, wherein both types, for example, can be applied at room temperature (23° C.) and also can cure at room temperature.

Suitable adhesives based on isocyanate-terminated polyurethane polymers can also include two-component polyurethane adhesives, the first component of which comprises an amine or a polyol, and the second component of which comprises a polyurethane polymer having isocyanate groups, or a polyisocyanate. Examples of two-component, room temperature curing polyurethane adhesives can include those from the SikaForce® product line, as are commercially available from Sika Schweiz AG.

Suitable adhesives based on isocyanate-terminated polymers can include reactive polyurethane hot-melt adhesives containing a thermoplastic polymer and an isocyanate group-terminated polymer or a thermoplastic isocyanate group-terminated polymer. Such reactive polyurethane hot melt adhesives can be melted and, on the one hand, solidify on cooling and, on the other, crosslink via a reaction with atmospheric moisture. For example, suitable reactive polyurethane hot melt adhesives are commercially available from Sika Schweiz AG under the name SikaMelt®.

The adhesive or sealant of the adhesive system of the disclosure can include at least one compound V in free or hydrolytically releasable form, which can react with the polyamine in a condensation reaction.

For example, compound V is a carbonyl compound. Exemplary carbonyl compounds are aldehydes, β-diketones, β-ketoesters and β-ketoamides.

For example, the proportion of compound V ranges from 0.2 to 20 wt-%, for example, 0.5 to 10 wt-%, based on the adhesive or sealant.

Suitable aldehydes include, for example, aldehydes that are liquid at room temperature, for example, propanal, 2-methylpropanal, butanal, 2-methylbutanal, 2-ethylbutanal, pentanal, pivalaldehyde, 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexanecarboxalhyde, 2,2-dimethyl-3-phenylpropanal; 1-naphthaldehyde, benzaldehyde or substituted benzaldehydes, for example, the isomeric tolualdehydes, salicylaldehyde and m-phenoxy-benzaldehyde; and cinnamaldehyde.

For example, suitable aldehydes include aldehydes of formula (II).

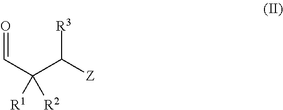

In this case, R1 and R2 either each independently are a monovalent hydrocarbon residue having 1 to 12 carbon atoms, or together are a divalent hydrocarbon residue having 4 to 12 carbon atoms which is part of an optionally substituted carbocyclic ring having 5 to 8, for example 6, carbon atoms. For example, R1 and R2 are each a methyl residue.

Furthermore, R3 is a hydrogen atom or an arylalkyl or cycloalkyl or alkyl group having 1 to 12 carbon atoms, for example, a hydrogen atom.

Z is an ester, ether, tertiary amino or amido group having up to 31 carbon atoms, optionally having additional ether oxygen atoms. For example, Z is a residue of formula (III) or (IV),

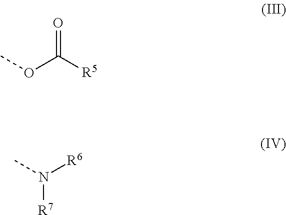

R5 is either a hydrogen atom or a linear or branched alkyl residue having 1 to 30 carbon atoms, optionally having cyclic components and optionally having at least one heteroatom, for example, oxygen in the form of ether, carbonyl or ester groups.

Furthermore, R5 may be a mono- or polyunsaturated, linear or branched hydrocarbon residue having 5 to 30 carbon atoms or an optionally substituted aromatic or hetero-aromatic 5- or 6-membered ring.

For example, R5 is a linear or branched alkyl residue having 6 to 30, for example, 11 to 30, carbon atoms, optionally having cyclic components and optionally having at least one heteroatom, or is a mono- or polyunsaturated, linear or branched hydrocarbon residue having 6 to 30, for example, 11 to 30, carbon atoms.

R6 and R7 each independently are a hydrogen atom, an alkyl, cycloalkyl, aryl or arylalkyl group having 1 to 12 carbon atoms, optionally having ether groups or halogen atoms, or together are a divalent hydrocarbon residue which is part of an optionally substituted carbocyclic ring having 5 to 8, for example 5 or 6, carbon atoms.

For example, R6 and R7 each independently are a methyl, ethyl, propyl, isopropyl, butyl, isobutyl, 2-ethylhexyl, cyclohexyl, benzyl or alkoxyethyl group, or together they form—including the nitrogen atom—a ring, for example, a pyrrolidine, piperidine, morpholine or N-alkylpiperazine ring, wherein this ring is optionally substituted. For example, R6 and R7 each independently are a benzyl or methoxyethyl group, or together, including the nitrogen atom, form a morpholine ring.

Exemplary aldehydes of formula (II) are liquid at room temperature.

Exemplary aldehydes of formula (II) having a residue of formula (III) as residue Z include esters of aliphatic, cycloaliphatic or arylaliphatic 2,2-disubstituted 3-hydroxy-aldehydes such as, for example, 2,2-dimethyl-3-hydroxypropanal, with suitable carboxylic acids, wherein suitable carboxylic acids include, for example, the following: saturated aliphatic carboxylic acids such as formic acid, acetic acid, propionic acid, butyric acid, isobutyric acid, valeric acid, caproic acid, 2-ethyl-caproic acid, enanthic acid, caprylic acid, pelargonic acid, capric acid, undecanoic acid, lauric acid, tridecanoic acid, myristic acid, pentadecanoic acid, palmitic acid, margaric acid, stearic acid, nonadecanoic acid, arachidic acid; monounsaturated aliphatic carboxylic acids such as palmitoleic acid, oleic acid, erucic acid; polyunsaturated aliphatic carboxylic acids such as linoleic acid, linolenic acid, eleostearic acid, arachidonic acid; cycloaliphatic carboxylic acids such as cyclohexanecarboxylic acid; arylaliphatic carboxylic acids such as phenylacetic acid; aromatic carboxylic acids such as benzoic acid, naphthoic acid, toluic acid, anisic acid; isomers of these acids; fatty acid mixtures from the industrial hydrolysis of natural oils and fats such as canola oil, sunflower oil, linseed oil, olive oil, coconut oil, oil palm kernel oil and oil palm oil; and dicarboxylic acid monoalkyl- and -aryl esters, such as those obtained from the simple esterification of dicarboxylic acids such as succinic acid, glutaric acid, adipic acid, pimelic acid, suberic acid, azelaic acid, sebacic acid, 1,12-dodecanedioic acid, maleic acid, fumaric acid, hexahydrophthalic acid, hexahydroisophthalic acid, hexahydroterephthalic acid, 3,6,9-trioxaundecanedioic acid and similar derivatives of polyethylene glycol, and alcohols such as methanol, ethanol, propanol, butanol, higher homologs and isomers of these alcohols. Exemplary are carboxylic acids having at least 7 carbon atoms, for example, those having 12 to 31 carbon atoms, for example, lauric acid, myristic acid, palmitic acid, stearic acid and oleic acid. For example, exemplary is lauric acid.

For example, the aldehyde can be selected from 2-ethylbutanal, pentanal, pivalaldehyde, 2-methylpentanal, 3-methylpentanal, 4-methylpentanal, 2,3-dimethylpentanal, hexanal, 2-ethylhexanal, heptanal, octanal, methoxyacetaldehyde, 2,2-dimethyl-3-phenylpropanal, benzaldehyde, 1-naphthaldehyde, salicylaldehyde and aldehydes of formula (II), for example, 3-acetoxy-2,2-dimethylpropanal, 2,2-dimethyl-3-lauroyloxypropanal, 2,2-dimethyl-3-(N-morpholino)-propanal, and 2,2-dimethyl-3-bis-(methoxyethyl)-amino-propanal.

For example, the aldehyde is selected from benzaldehyde, salicylaldehyde, 2,2-dimethyl-3-phenylpropanal, 3-acetoxy-2,2-dimethylpropanal, 2,2-dimethyl-3-lauroyloxypropanal and 2,2-dimethyl-3-(N-morpholino)-propanal.

Exemplary aldehydes are aldehydes of formula (II) having a residue of formula (III) as residue Z with R5 having 11 to 30 carbon atoms, for example, 11 to 20 carbon atoms. Exemplary is 2,2-dimethyl-3-lauroyloxypropanal.

The aldehydes can be odorless substances. The odorless substance can be a substance that cannot be smelled by most human individuals, thus having no perceptible odor. When using such aldehydes, adhesives and sealants are available, for example, which are odorless and do not release VOCs.

Suitable β-diketones can include those of formula (V)

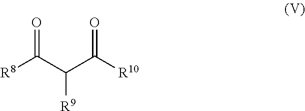

In an exemplary embodiment, R8 and R10 each independently are an alkyl, cycloalkyl, aryl or arylalkyl group having 1 to 12 carbon atoms, optionally having ether groups or halogen atoms, and R9 is a hydrogen atom or an alkyl, cycloalkyl, aryl or arylalkyl group having 1 to 12 carbon atoms.

In an exemplary embodiment, R8 and R9 together are a divalent hydrocarbon residue, which is part of an optionally substituted, carbocyclic ring having 5 to 8, for example 5 or 6, carbon atoms, and R10 is an alkyl, cycloalkyl, aryl or arylalkyl group having 1 to 12 carbon atoms, optionally having ether groups or halogen atoms.

Exemplary β-diketones of formula (V) are selected, for example, from 2,4-pentanedione, 2,4-pentanedione alkylated in the 3-position, i.e., for example, 3-methyl-, 3-ethyl-, 3-propyl-, 3-isopropyl-, 3-butyl, 3-tert-butyl, 3-cyclohexyl- and 3-phenyl-2,4-pentanedione, 1,1,1-trifluoro-2,4-pentanedione, 1,1,1,5,5,5-hexafluoro-2,4-pentanedione, 3,5-heptanedione, 3,5-octanedione, 2,4-octanedione, 6-methyl-3,5-heptanedione, 2,2,6,6-tetramethyl-3,5-heptanedione, 2,2,4,6,6-pentamethyl-3,5-heptanedione, 1-phenyl-1,3-butanedione, 2-acetylcyclopentanone, 2-acetylcyclohexanone, 2-benzoylcyclopentanone and 2-benzoylcyclohexanone.

Exemplary is 2,4-pentanedione.

Suitable β-ketoesters can include β-ketoesters of formula (VI).

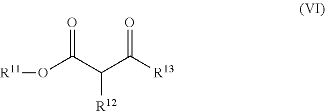

R11 is a linear or branched alkyl group having 1 to 6 carbon atoms, for example, a tert-butyl group. R12 and R13 each independently are a hydrogen atom, an alkyl, cycloalkyl, aryl or arylalkyl group having 1 to 12 carbon atoms, optionally having ether groups or halogen atoms, or together are a divalent hydrocarbon residue forming part of an optionally substituted carbocyclic ring having 5 to 8, for example 5 or 6, carbon atoms. For example, R12 is a hydrogen atom and R13 is a methyl group.

Suitable β-ketoamides can include β-ketoamides of formula (VII).

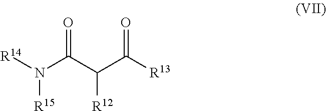

R12 and R13 independently correspond to the residues, as have been above for β-ketoesters of formula (VI). R14 and R15 each independently are a hydrogen atom, an alkyl, cycloalkyl, aryl or arylalkyl group having 1 to 12 carbon atoms, optionally having ether groups or halogen atoms, or together are a divalent hydrocarbon residue which forms part of an optionally substituted carbocyclic ring having 5 to 8, for example 5 or 6, carbon atoms.

Compound V may also be a polyfunctional compound having two or more of the carbonyl groups contained in the carbonyl compound described above, wherein within one molecule these carbonyl groups need not be identical. For example, a suitable compound V is a dialdehyde, such as terephthalaldehyde, or a polyol, the hydroxyl groups of which are all acetoacetylated.

For example, instead of being in free form, compound V can be included in the adhesive or sealant in hydrolytically releasable form.

Suitable compounds which release a compound V after hydrolysis can include aldimines, enamines, or oxazolidines.

For example, the compound V in hydrolytically releasable form can be an aldimine of formula (VIII).

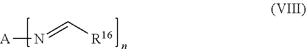

Here, n is a number from 1 to 4, for example, 2 or 3. A is an n-valent hydrocarbon residue having 2 to 30 carbon atoms, optionally containing at least one heteroatom, for example, in the form of ether oxygen or tertiary amine nitrogen.

For example, A is a residue of an amine after removal of n amino groups. Exemplary amines are selected from 1,6-hexamethylenediamine, 1,5-diamino-2-methylpentane, 1,3-pentanediamine, isophoronediamine, 2,2,4- and 2,4,4-trimethylhexamethylenediamine, 1,3-xylylenediamine, 1,3-bis-(aminomethyl)-cyclohexane, bis-(4-aminocyclohexyl)-methane, bis-(4-amino-3-methylcyclohexyl)-methane, 3(4), 8(9)-bis-(aminomethyl)-tricyclo[5.2.1.02,6]decane, 1,2-, 1,3- and 1,4-diaminocyclohexane, 1,4-diamino-2,2,6-trimethylcyclohexane, 3,6-dioxaoctane-1,8-diamine, 4,7-dioxadecane-1,10-diamine, 4-aminomethyl-1,8-octanediamine, polyoxyalkylene polyamines having two or three amino groups and a molecular weight of up to 600 g/mol, for example, types D-230, D-400 and T-403 available from Huntsman under the trade name Jeffamine®, and analogous compounds from BASF or Nitroil; 1,3- and 1-4-phenylenediamine, 2,4- and 2,6-toluylenediamine, 4,4′-, 2,4′- and 2,2′-diaminodiphenylmethane, 3,3′-dichloro-4,4′-diaminodiphenylmethane, and mixtures of said amines.

R16 can be a residue of an aldehyde, as has been described above, after removal of the aldehyde group.

Other suitable exemplary aldimines are described, for example, as polyaldimines PA in WO 2010/112537. Suitable aldimines can also include aldimines such as Vestamin® A-139 (Evonik).

For example, compound V in hydrolytically releasable form is an enamine. For example, such an enamine can be obtained from the condensation reaction of an amine having at least one secondary amino group with at least one aldehyde, which has at least one hydrogen atom in the a-position to the carbonyl group, thus being enolizable, for example, acetaldehyde, propanal, 2-methylpropanal, butanal, 2-methylbutanal, 2-ethylbutanal, pentanal, 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexanecarboxaldehyde or diphenylacetaldehyde. Suitable amines having at least one secondary amino group include, on the one hand, amines having at least two secondary amino groups, for example, piperazine, 2,5- and 2,6-dimethylpiperazine, 2,3,5,6-tetramethylpiperazine, 1,7-dioxa-4,10-diazacyclododecane, N,N′-dibutylethylenediamine, N,N′-di-tert-butyl- ethylenediamine, N,N′-dimethyl-1,6-hexanediamine, N,N′-diethyl-1,6-hexanediamine, N,N′-dimethyl-diethylenetriamine, N,N′-dimethyl-dipropylenetriamine, 1-(1-methylethylamino)-3-(1-methylethylaminomethyl)-3,5,5-trimethylcyclohexane (Jefflink® 754, Huntsman), N4-cyclohexyl-2-methyl-N2-(2-methylpropyl)-2,4-pentanediamine, N,N′-dialkyl-1,3-xylylenediamine, bis-(4-(N-alkylamino)-cyclohexyl)-methane, 4,4′-trimethylenedipiperidine and N-alkylated polyetheramines, for example, Jeffamine® SD-231 (Huntsman); furthermore, amines having a hydroxyl group and a secondary amino group, for example, N-(2-hydroxyethyl)-piperazine, 4-hydroxypiperidine, and monoalkoxylated primary monoamines such as, for example, N-methylethanolamine, N-ethylethanolamine, N-butylethanolamine and N-butylisopropanolamine; furthermore, amines having a mercapto group and a secondary amino group, for example, N-(2-mercaptoethyl)-piperazine, 4-mercaptopiperidine and 2-mercaptoethylbutylamine.

Furthermore, compound V in hydrolytically releasable form can be an oxazolidine. For example, such an oxazolidine can be obtained from the condensation reaction of at least one hydroxyamine, in which the hydroxyl group and the primary or secondary amino group are separated by an optionally substituted ethylene or propylene residue, with at least one aldehyde, for example, formaldehyde, or one of the above enolizable aldehydes. For example, suitable are 2-methylpropanal and 2-ethylhexanal. Suitable hydroxyamines include, for example, diethanolamine and diisopropanolamine, which result in hydroxyoxazolidines, from which polyoxazolidines can be prepared easily, for example, by reaction with a polyisocyanate or a polyester.

Suitable commercial oxazolidines include, for example, Harter OZ and Desmophen® VP LS 2959 (Bayer), Zoldine® ZA-78 and Zoldine® ZE (Dow Chemical), Zoldine® RD-4 and Zoldine® RD-20 (Angus Chemie) and Incozol® 2, Incozol® 3, Incozol® LV, Incozol® 4, Incozol® HP, Incozol® CF, Incozol® NC, and Incozol® K (Incorez).

In an exemplary embodiment of the adhesive system, the adhesive or sealant is a polyurethane adhesive or sealant, which contains polyurethane polymers having isocyanate groups, wherein it contains a compound V in hydrolytically releasable form. For example, compounds which release compound V after hydrolysis are polyaldimines, polyenamines and polyoxazolidines.

This exemplary embodiment can be desirable because, due to the use of a suitable polyaldimine in the adhesive or sealant, said adhesive or sealant can release compound V in a delayed manner upon contact with water, which can ensure the stability of the adhesive bond under humid and warm conditions. The delayed release of compound V can ensure an undisrupted curing of the solid epoxy resin with the polyamine.

Simultaneously with the release of compound V, a polyamine or an amino alcohol can be released, which, by reaction of the amino groups or hydroxyl groups and the isocyanate groups of the polyurethane polymer, can result in a curing of the polyurethane adhesive or sealant.

Furthermore, disclosed is an exemplary method for applying an adhesive system of the disclosure comprising:

i) applying a bonding agent composition containing

at least one aqueous dispersion of a solid epoxy resin; and

at least one polyamine; to a substrate;

ii) applying an adhesive or sealant containing

at least one compound V in free or hydrolytically releasable form which can react with the polyamine in a condensation reaction;

at least in part to the area in which the bonding agent composition was applied.

The use of such an adhesive system can improve the adhesion of the adhesive or sealant in humid and warm conditions, for example, after cataplasm storage.

In the method described above, the bonding agent composition can be applied by means of a cloth, felt, roller, spray, sponge, brush, by dip coating or the like, which can be carried out either manually or by means of a robot.

If the bonding agent composition is a two-component bonding agent composition, mixing of the two components can take place before or during application.

After application of the bonding agent composition and before application of the adhesive or sealant, the bonding agent composition can be flashed off. The flashing off can be carried out under atmospheric conditions or, if desired, at an elevated temperature, reduced pressure and/or by blowing with a gas, which can result in a shortening of the flash-off time.

The adhesive or sealant is then applied, for example, in the form of a bead, to the substrate by means of a suitable device, at least partially at the site to which the bonding agent composition was applied.

The adhesive system of the disclosure is suitable for various substrates such as metals and alloys, for example, steels, aluminum and nonferrous metals and their alloys, concrete, mortar, brick, clinker, natural stone, glass, glass ceramics, wood and plastics such as polystyrene. Exemplary substrates include inorganic substrates, for example, glass and glass ceramics, concrete and mortar.

The substrates may be pretreated as desired before applying the bonding agent composition. For example, such pretreatments include physical and/or chemical cleaning methods, such as grinding, sand blasting, brushing or the like, or treatment with detergents or solvents.

Exemplary areas of application of the adhesive system of the disclosure include the construction and manufacturing industries and the automotive industry, for example, for joint sealing, gluing parquet, gluing add-on pieces, seam sealing, vacuum sealing, assembly, vehicle body gluing, window gluing and the like.

For example, items that result from the gluing, sealing or coating of a substrate using an adhesive system of the disclosure can include, for example, buildings, for example, buildings of construction or civil engineering, means of transportation, such as vehicles, for example, automobiles, buses, trucks, rail cars or ships, or add-on pieces thereof. For example, the adhesive system of the disclosure can be used for elastic bonding in vehicle construction, such as for the gluing of parts such as plastic covers, trims, flanges, bumpers, driver's cabins or other add-on pieces, to the painted body of a means of transportation, or the bonding of windows to the body.

### EXAMPLES

In the following, embodiments are set forth which are intended to illustrate the disclosure in more detail. It is understood that the disclosure is not limited to these described embodiment examples.

### Preparation of the Bonding Agent Composition

Ancarez™ AR555 (Air Products; 55 wt-% solids content), a commercial aqueous dispersion of a solid epoxy resin, was used as component K1.

Anquamine® 419 (Air Products; 60 wt-% solids content), a commercial aqueous amine curing agent, diluted with deionized water to a solids content of 17 wt-%, was used as component K2.

### Preparation of the Adhesives

### Adhesive 1:

Under exclusion of moisture, in a vacuum mixer, 500 g of the commercial single-component polyurethane adhesive Sikaflex®-221 (Sika Schweiz AG) and 5.5 g of N,N-diethylacetoacetamide were processed into a homogeneous paste, the same was dispensed immediately into an internally coated aluminum cartridge and the cartridge was sealed airtight.

### Adhesive 2:

Under exclusion of moisture, in a vacuum mixer, 500 g of the commercial single-component polyurethane adhesive Sikaflex®-221 (Sika Schweiz AG) and 12.0 g of a dialdimine (prepared from 51 g of 2,2-dimethyl-3-lauroyloxypropanal and 10 g of 1,6-hexanediamine) and 0.5 g of benzoic acid were processed into a homogeneous paste, the same was dispensed immediately into an internally coated aluminum cartridge and the cartridge was sealed airtight.

### Preparation of Bonds

For application of the bonding agent composition, 50 parts by weight of component K1 and 50 parts by weight of component K2 were mixed together, the mixture was applied to the substrate using a felt soaked with the mixture (float glass, Rocholl GmbH, Germany; tin side) and was flashed off for 60 minutes in “standard climate” (23±1° C., 50±5% relative humidity).

The respective adhesive according to Table 1 was applied as a triangular bead by means of a cartridge gun under standard climate conditions to the substrate pretreated in this manner. The adhesive was tested for adhesion after a curing time of 7 days under standard climate conditions (“RT”) and after subsequent cataplasm storage for 7 days (“CP”).

The adhesion of the adhesive was determined by a bead test. Here, the end of the bead is cut just above the adhesive surface. The cut end of the bead is held with pliers and is pulled away from the substrate. This is accomplished by carefully rolling the bead up onto the tip of the pliers, and placing a cut perpendicular to the bead pulling direction down to the bare substrate. The bead pulling speed is chosen such that about every 3 seconds a cut can be made.

The test distance is at least 8 cm. The adhesive that is left on the substrate after the removal of the bead (cohesive failure) is analyzed. The adhesion properties are evaluated by a visual determination of the cohesive component of the adhesion area as a percentage. The suffix “P” in the score denotes a detachment of the bonding agent or primer from the substrate or a cohesive failure in the bonding agent. The higher the percentage of cohesive failure in the adhesive, the better assessment the bonding will receive. Test results with cohesive failures of less than 50%, for example, less than 40%, are considered inadequate. The results are shown in Table 1.

TABLE 1
Adhesion results

| Adhesive | Adhesion after RT | Adhesion after CP |
|---|---|---|
| Sikaflex ®-221 (ref.) | 100 | 0P |
| Adhesive 1 | 100 | 90P |
| Adhesive 2 | 100 | 100 |

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An adhesive system, comprising:
a bonding agent composition containing:
at least one aqueous dispersion of a solid epoxy resin; and
at least one polyamine;
and
an adhesive or sealant containing:
at least one compound in free or hydrolytically releasable form, which is capable of reacting with the polyamine in a condensation reaction.

2. The adhesive system according to claim 1, wherein the aqueous dispersion of the solid epoxy resin has a content of solid epoxy resin of 30 to 80 wt-%.

3. The adhesive system according to claim 1, wherein the solid epoxy resin is in the form of dispersed particles of the solid epoxy resin, wherein a mean particle size of the dispersed particles of the solid epoxy resin in the dispersion is in the range of 0.05 to 20 μm.

4. The adhesive system according to claim 1, wherein a proportion of the aqueous dispersion of the solid epoxy resin is 30 to 99 wt -%, based on the total bonding agent composition.

5. The adhesive system according to claim 1, wherein the bonding agent composition is a two-component bonding agent composition comprising:
a first component K1 containing the at least one aqueous dispersion of the solid epoxy resin; and
a second component K2 containing the at least one polyamine.

6. The adhesive system according to claim 1, wherein the compound in free or hydrolytically releasable form, is contained in the adhesive or sealant in hydrolytically releasable form.

7. The adhesive system according to claim 6, wherein the compound which releases the compound in free or hydrolytically releasable form, after hydrolysis is a polyaldimine.

8. The adhesive system according to claim 1, wherein the adhesive or sealant is a polyurethane adhesive or sealant containing polyurethane polymers having isocyanate groups.

9. The adhesive system according to claim 8, wherein the polyurethane adhesive or sealant which contains polyurethane polymers having isocyanate groups, is capable of being applied at room temperature and is capable of being cured at room temperature.

10. A process for using an adhesive system, the process comprising:
i) applying a bonding agent composition to a substrate, wherein the bonding agent composition contains:
at least one aqueous dispersion of a solid epoxy resin; and
at least one polyamine; and
ii) applying an adhesive or sealant at least partially to a site at which the bonding agent composition was applied, wherein the adhesive or sealant contains:
at least one compound in free or hydrolytically releasable form, which is capable of reacting with the polyamine in a condensation reaction.

11. The adhesive system according to claim 1, wherein the compound in free or hydrolytically releasable form, is a carbonyl compound.

12. The adhesive system according to claim 1, wherein the compound in free or hydrolytically releasable form, is a carbonyl compound selected from the group consisting of an aldehyde, β-diketone, β-ketoester, β-ketoamide and a combination thereof.

13. The adhesive system according to claim 1, wherein an amount of compound in free or hydrolytically releasable form, is from 0.2 to 20 wt-%, based on the adhesive or sealant.

14. The adhesive system according to claim 1, wherein an amount of compound in free or hydrolytically releasable form, is from 0.5 to 10 wt-%, based on the adhesive or sealant.

15. The adhesive system according to claim 1, wherein the polyamine is a polyamidoamine or an epoxy resin/polyamine addition product.

16. The adhesive system according to claim 1, wherein an amount of the polyamine is 1 to 40 wt-%, based on the total bonding agent composition.

17. The adhesive system according to claim 1, wherein an amount of the polyamine is 5 to 20 wt-%, based on the total bonding agent composition.

18. The adhesive system according to claim 1, wherein in the bonding agent composition, a ratio of amino groups to epoxy groups is in a range of 0.1:1 to 1:1.

19. The adhesive system according to claim 2, wherein the solid epoxy resin is in the form of dispersed particles of the solid epoxy resin, wherein a mean particle size of the dispersed particles of the solid epoxy resin in the dispersion is in the range of 0.05 to 20 μm.

20. The adhesive system according to claim 2, wherein a proportion of the aqueous dispersion of the solid epoxy resin is 30 to 99 wt -%, based on the total bonding agent composition.
